(19) United States
(12) Patent Application Publication
(10) Pub. No.: US 2025/0189320 A1
(43) Pub. Date: Jun. 12, 2025

(54) METHODS AND APPARATUS FOR PROVIDING MAPS FOR USE WITH AUTONOMY SYSTEMS

(71) Applicant: Nuro, Inc., Mountain View, CA (US)

(72) Inventors: Gregory Long, Mountain View, CA (US); Peiyan Gong, Los Altos, CA (US); Samuel Maxwell Bateman, Mountain View, CA (US); Ning Xu, Santa Clara, CA (US); Haicheng Charles Zhao, Sunnyvale, CA (US)

(21) Appl. No.: 18/972,163

(22) Filed: Dec. 6, 2024

Related U.S. Application Data
(60) Provisional application No. 63/608,594, filed on Dec. 11, 2023.

(51) Int. Cl. G01C 21/30; G06T 3/4038; G06V 20/56

(52) U.S. Cl. CPC G01C 21/30; G06T 3/4038; G06V 20/56

(57) ABSTRACT

According to one aspect, a method includes obtaining sensor data from a plurality of sensors onboard a vehicle, and obtaining prior map data from a server that is offboard with respect to the vehicle. The method also includes processing the sensor data using a first arrangement onboard the vehicle to generate processed sensor data, and generating an inferred context map using a map prediction arrangement located onboard the vehicle, wherein generating the inferred context map includes processing the processed sensor data and the prior map data using the map prediction arrangement.

### CROSS-REFERENCE TO RELATED APPLICATIONS

This patent application claims the benefit of priority under 35 U.S.C. § 119 of U.S. Provisional Patent Application No. 63/608,594, filed Dec. 11, 2023, and entitled “METHODS AND APPARATUS FOR CONTEXT MAP INFERENCE,” which is hereby incorporated by reference in its entirety.

### TECHNICAL FIELD

The disclosure relates to providing maps for use with autonomous vehicles. More particularly, the disclosure relates to using offline and online inferences to provide context map features which may be used in maps used by autonomous vehicles.

### BACKGROUND

In order for vehicles to drive autonomously, maps of environments in which the vehicles are used. The accuracy of the maps used to facilitate autonomous driving is critical, as an inaccurate or incomplete map may lead to performance issues such as safety concerns.

Context maps provide contextual information that may be used by vehicles while the vehicles operate autonomously. The context maps may be used in conjunction with other maps to provide context for features of the other maps. For example, context maps may identify features such as curbs on roads and road boundaries. The accuracy of context maps is critical to the safe operation of autonomous vehicles.

### BRIEF DESCRIPTION OF THE DRAWINGS

The disclosure will be readily understood by the following detailed description in conjunction with the accompanying drawings in which:

FIG. 1 is a diagrammatic representation of an autonomous vehicle fleet in accordance with an embodiment.

FIG. 2 is a diagrammatic representation of a side of an autonomous vehicle in accordance with an embodiment.

FIG. 3 is a block diagram representation of an autonomous vehicle in accordance with an embodiment.

FIG. 4A is a diagrammatic representation of a platform for providing context map inference that includes a vehicle and a server in accordance with an embodiment.

FIG. 4B is a diagrammatic representation of a platform for providing context map inference, e.g., platform 440 of FIG. 4A, that depicts components of a vehicle and a server in accordance with an embodiment.

FIG. 5A is a process flow diagram which illustrates a general method of implementing context map inference in accordance with an embodiment.

FIG. 5B is a process flow diagram which illustrates a method of a vehicle comparing offboard context map prior data to sensor data, e.g., step 517 of FIG. 5A, in accordance with an embodiment.

FIGS. 6A and 6B are a process flow diagram which illustrates a method of implementing context map inference with respect to an architecture in accordance with an embodiment.

FIG. 7 is a diagrammatic representation of a vehicle architecture which produces an inferred context map for use by an autonomy system in accordance with an embodiment.

FIG. 8 is a diagrammatic representation of a vehicle architecture which is arranged to process onboard sensor data before providing the onboard sensor data to a machine learning or deep learning model, e.g., machine learning model 756 of FIG. 7, in accordance with an embodiment.

FIG. 9 is a process flow diagram which illustrates a process of training a machine learning or deep learning model included in a context map generation arrangement.

FIG. 9 is a process flow diagram which illustrates a method of generating an inferred context map in accordance with an embodiment.

FIG. 10 is a process flow diagram which illustrates a method of training a map prediction or machine learning model in accordance with an embodiment.

### DESCRIPTION OF EXAMPLE EMBODIMENTS

### General Overview

According to one aspect, a method includes obtaining sensor data from a plurality of sensors onboard a vehicle, and obtaining prior map data from a server that is offboard with respect to the vehicle. The method also includes processing the sensor data using a first arrangement onboard the vehicle to generate processed sensor data, and generating an inferred context map using a map prediction arrangement located onboard the vehicle, wherein generating the inferred context map includes processing the processed sensor data and the prior map data using the map prediction arrangement.

In one embodiment, logic is encoded in one or more tangible non-transitory, computer-readable media for execution. When executed, the logic is operable to obtain sensor data from a plurality of sensors onboard a vehicle, and to obtain prior map data from a server, the server being offboard with respect to the vehicle. The logic is also operable to process the sensor data to generate processed sensor data onboard the vehicle, and to generate an inferred context map onboard the vehicle. The logic operable to generate the inferred context map includes logic operable to process the processed sensor data and the prior map data.

In still another embodiment, a vehicle includes a chassis, as well as a sensor system, a communications system, and one or more tangible non-transitory, computer-readable media carried on the chassis. When executed, the logic is operable to obtain sensor data from the sensor system, obtain prior map data from an offboard server using the communications system, and process the sensor data to generate processed sensor data. The logic is also operable to generate an inferred context map, wherein the logic operable to generate the inferred context map includes logic operable to process the processed sensor data and the prior map data.

An autonomous vehicle may use data captured by onboard sensors as input to a machine learning model that is arranged to infer a context map or context map features based on the captured data. That is, context map features are inferred from data captured by sensors on an autonomous vehicle. Prior data associated with context maps is stored offboard, and provided to the vehicle to effectively enable a machine learning model to infer a context map that may be used by the vehicle to drive autonomously. The prior data may, in some instances, enable a comparison to be made between the context map features obtained from the machine learning model and features associated with the prior data. The prior data may be used to affirm whether features detected by onboard sensors are accurate or otherwise correct. In one embodiment, the comparison made between the context map features obtained from the machine learning model and features obtained from the prior data may be used to determine whether the context map features are to be added to the inferred context map.

### Description

Autonomous vehicles typically use maps to enable autonomous operations. The maps may generally provide fundamental information about roads, and may be used to enable an autonomous vehicle to perform localization and motion planning. Standard definition (SD) and high definition (HD) maps may cooperate to provide information about roads that include lane information. Context maps provide contextual details relating to features found in SD and HD maps, among other maps. The contextual details may identify features including, but not limited to including, road boundaries, curbs, crosswalks, lane lines, and the like.

The ability to accurately infer features associated with a context map increases the efficiency of an overall mapping process. For example, a need to manually label or annotate features on a map may be substantially replaced. In one embodiment, context map data is collected using sensors onboard an autonomous vehicle while the autonomous vehicle is driving. The collected or perceived data, e.g., perception data or data from a perception system, may be processed to effectively create a real-time context map, as for example using a machine learning or deep learning model which enables a determination to be made as to which features are effectively identified or otherwise indicated in the collected or perceived data. The context map substantially generated using data perceived by onboard sensors may be compared to prior context map data associated with substantially the same environment, or a similar environment, in which the autonomous vehicle is driving. The prior context map data may be compared to the current context map data to identify any discrepancies. When there are no significant discrepancies, a real-time context map generated using the current context map data may be considered to be accurate and, therefore, safe for an autonomous vehicle to use for navigation purposes. In one embodiment, when there are significant discrepancies between prior context map data and current context map data, a process of determining how to address the discrepancies such that the vehicle may operate safely may effectively be triggered by the vehicle.

The use of prior context map data and onboard sensor data may be used to generate an onboard context map, or an inferred context map, in any suitable matter. In one embodiment, a prior context map may be used as input to a machine learning model which may compare the prior context map with sensor data to assess whether the prior context map is accurate and, if the prior context map is not accurate, the machine learning model may generate a new, onboard context map. In another embodiment, a prior context map may be combined with sensor data and used as input to a machine learning model which produces an onboard context map that is effectively a combination of the prior context map and the sensor data.

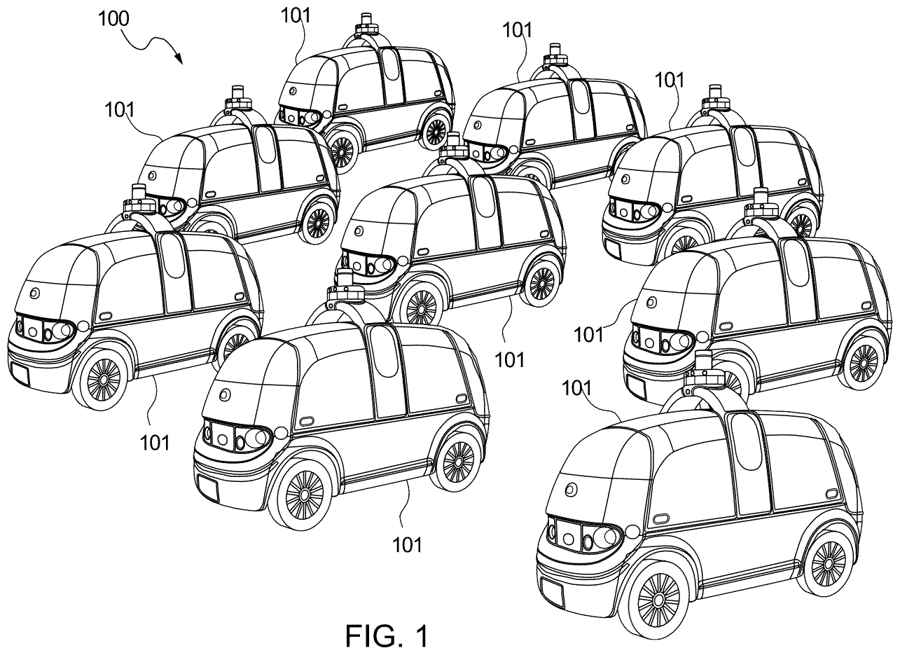

Vehicles which utilize maps including context maps may be part of a fleet of vehicles. Referring initially to FIG. 1, an autonomous vehicle fleet will be described in accordance with an embodiment. An autonomous vehicle fleet 100 includes a plurality of autonomous vehicles 101, or robot vehicles. Autonomous vehicles 101 are generally arranged to transport and/or to deliver cargo, items, and/or goods. Autonomous vehicles 101 may be fully autonomous and/or semi-autonomous vehicles. In general, each autonomous vehicle 101 may be a vehicle that is capable of travelling in a controlled manner for a period of time without intervention, e.g., without human intervention. As will be discussed in more detail below, each autonomous vehicle 101 may include a power system, a propulsion or conveyance system, a navigation module, a control system or controller, a communications system, a processor, and a sensor system.

Dispatching of autonomous vehicles 101 in autonomous vehicle fleet 100 may be coordinated by a fleet management module (not shown). The fleet management module may dispatch autonomous vehicles 101 for purposes of transporting, delivering, and/or retrieving goods or services in an unstructured open environment or a closed environment.

While autonomous vehicle fleet 100 includes one or more autonomous vehicles 101 which are generally configured to transport and/or to deliver cargo, items, and/or goods, it should be appreciated that autonomous vehicle fleet 100 is not limited to including one or more autonomous vehicles 101. For example, autonomous vehicle fleet 100 may additionally, or alternatively, include autonomous vehicles (not shown) which are configured to transport and/or to deliver passengers.

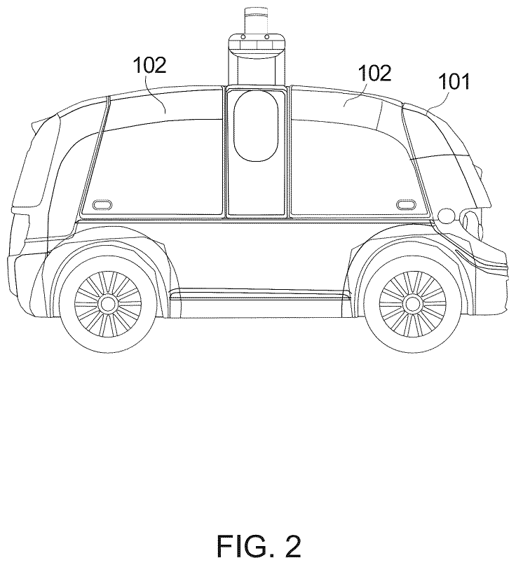

FIG. 2 is a diagrammatic representation of a side of an autonomous vehicle, e.g., one of autonomous vehicles 101 of FIG. 1, in accordance with an embodiment. Autonomous vehicle 101, as shown, is a vehicle configured for land travel. Typically, autonomous vehicle 101 includes physical vehicle components such as a body or a chassis, as well as conveyance mechanisms, e.g., wheels. In one embodiment, autonomous vehicle 101 may be relatively narrow, e.g., approximately two to approximately five feet wide, and may have a relatively low mass and relatively low center of gravity for stability. Autonomous vehicle 101 may be arranged to have a working speed or velocity range of between approximately one and approximately forty-five miles per hour (mph), e.g., approximately twenty-five miles per hour. In some embodiments, autonomous vehicle 101 may have a substantially maximum speed or velocity in range between approximately thirty and approximately ninety mph.

Autonomous vehicle 101 includes a plurality of compartments 102. Compartments 102 may be assigned to one or more entities, such as one or more customer, retailers, and/or vendors. Compartments 102 are generally arranged to contain cargo, items, and/or goods. Typically, compartments 102 may be secure compartments. It should be appreciated that the number of compartments 102 may vary. That is, although two compartments 102 are shown, autonomous vehicle 101 is not limited to including two compartments 102.

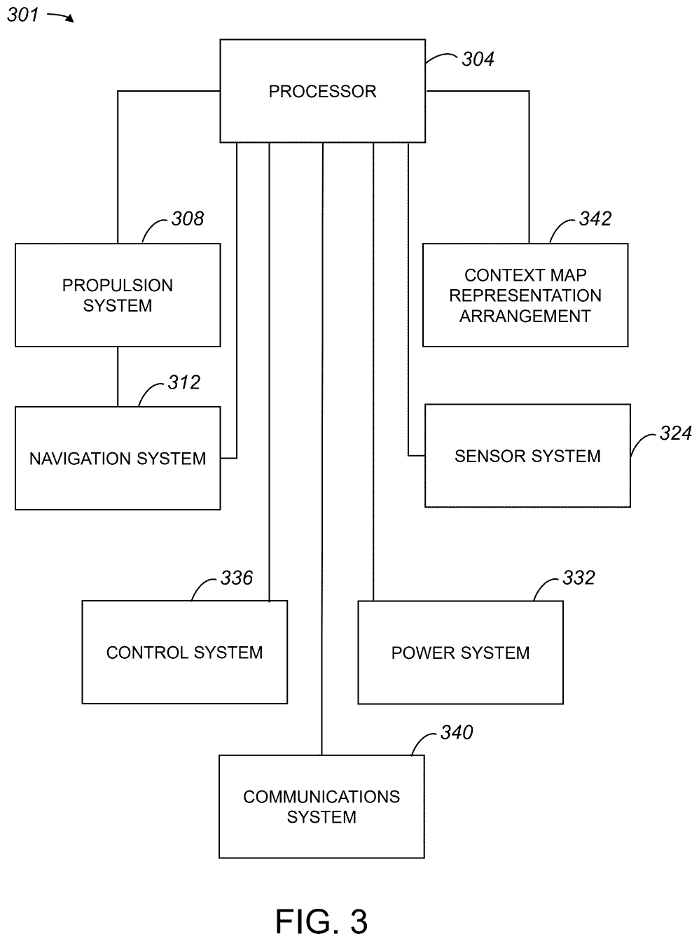

While autonomous vehicle 101 has been shown as a delivery vehicle, an autonomous vehicle is not limited to being a delivery vehicle arranged to transport cargo. In other words, autonomous vehicle 101 is an example of a vehicle which may utilize inferred context maps. Other vehicles may be configured to utilize inferred context maps. For example, an autonomous vehicle may be arranged to carry occupants or passengers in addition to, or in lieu of, cargo. FIG. 3 is a block diagram representation of an autonomous vehicle in accordance with an embodiment. An autonomous vehicle 301 includes a processor 304, a propulsion system 308, a navigation system 312, a sensor system 324, a power system 332, a control system 336, a communications system 340, and a context map representation arrangement 342. It should be appreciated that processor 304, propulsion system 308, navigation system 312, sensor system 324, power system 332, communications system 340, and context map representation arrangement 342 are all coupled to, or otherwise support on, a chassis or body of autonomous vehicle 301. In one embodiment, autonomous vehicle 301 may be similar to autonomous vehicle 101 of FIGS. 1 and 2.

Processor 304 is arranged to send instructions to and to receive instructions from or for various components such as propulsion system 308, navigation system 312, sensor system 324, power system 332, and control system 336. Propulsion system 308, or a conveyance system, is arranged to cause autonomous vehicle 301 to move, e.g., drive. For example, when autonomous vehicle 301 is configured with a multi-wheeled automotive configuration as well as steering, braking systems and an engine, propulsion system 308 may be arranged to cause the engine, wheels, steering, and braking systems to cooperate to drive. In general, propulsion system 308 may be configured as a drive system with a propulsion engine, wheels, treads, wings, rotors, blowers, rockets, propellers, brakes, etc. The propulsion engine may be a gas engine, a turbine engine, an electric motor, and/or a hybrid gas and electric engine. When autonomous vehicle 301 is arranged to be driven either autonomously or non-autonomously, a steering system of propulsion system 308 may include a steering wheel, and a braking system may include a gas pedal and a brake pedal.

Navigation system 312 may control propulsion system 308 to navigate autonomous vehicle 301 through paths and/or within unstructured open or closed environments. Navigation system 312 may include at least one of digital maps, street view photographs, and a global positioning system (GPS) point. Maps, for example, may be utilized in cooperation with sensors included in sensor system 324 to allow navigation system 312 to cause autonomous vehicle 301 to navigate through an environment.

Sensor system 324 includes any sensors, as for example lidar, radar, ultrasonic sensors, microphones, altimeters, and/or cameras. Sensor system 324 generally includes onboard sensors which allow autonomous vehicle 301 to safely navigate, and to ascertain when there are objects near autonomous vehicle 301. In one embodiment, sensor system 324 may include propulsion systems sensors that monitor drive mechanism performance, drive train performance, and/or power system levels. Data collected by sensor system 324 may be used by a perception system associated with navigation system 312 to determine or to otherwise understand an environment around autonomous vehicle 301.

Power system 332 is arranged to provide power to autonomous vehicle 301. Power may be provided as electrical power, gas power, or any other suitable power, e.g., solar power or battery power. In one embodiment, power system 332 may include a main power source, and an auxiliary power source that may serve to power various components of autonomous vehicle 301 and/or to generally provide power to autonomous vehicle 301 when the main power source does not have the capacity to provide sufficient power.

Communications system 340 allows autonomous vehicle 301 to communicate, as for example, wirelessly, with a fleet management system (not shown) that allows autonomous vehicle 301 to be controlled remotely. Communications system 340 generally obtains or receives data, stores the data, and transmits or provides the data to a fleet management system and/or to autonomous vehicles 301 within a fleet 100. The data may include, but is not limited to including, information relating to scheduled requests or orders, information relating to on-demand requests or orders, and/or information relating to a need for autonomous vehicle 301 to reposition itself, e.g., in response to an anticipated demand.

In one embodiment, context map representation arrangement 342 is arranged to enable vehicle 301 to implement machine learning-based context map inference. Context map representation arrangement 342 may generally obtain context map prior data from an offboard source or a source that is remote with respect to vehicle 301, and obtain data from sensor system 324, and process the prior data and the data from sensor system 324. Processing the prior data and data from sensor system 324 may involve generating a context map for downstream use, e.g., by systems in vehicle 301 that effectively form an autonomy system. It should be appreciated that context map representation arrangement 342 may identify whether there are discrepancies between the prior data and data from sensor system 324. If there are no discrepancies, or if discrepancies are below a threshold amount or level, between the prior data and the data from sensor system 324, context map representation arrangement 342 may generate a context map that uses data from sensor system 324 for an autonomy system of vehicle 301 to use. If there are discrepancies, or if discrepancies exceed a threshold amount or level, then context map representation arrangement 342 may cause an action to be taken. The action may include, but is not limited to including, vehicle 301 ceasing to operate in an autonomous mode and awaiting assistance such as control by a teleoperator or extraction, context map representation arrangement 342 issuing a notification that identifies discrepancies, and/or context map representation arrangement 342 requesting additional information that may be used to address discrepancies.

In some embodiments, control system 336 may cooperate with processor 304 to determine where autonomous vehicle 301 may safely travel, and to determine the presence of objects in a vicinity around autonomous vehicle 301 based on data, e.g., results, from sensor system 324. In other words, control system 336 may cooperate with processor 304 to effectively determine what autonomous vehicle 301 may do within its immediate surroundings. Control system 336 in cooperation with processor 304 may essentially control power system 332 and navigation system 312 as part of driving or conveying autonomous vehicle 301. Additionally, control system 336 may cooperate with processor 304 and communications system 340 to provide data to or obtain data from other autonomous vehicles 301, a management server, a global positioning server (GPS), a personal computer, a teleoperations system, a smartphone, or any computing device via the communications system 340. In general, control system 336 may cooperate at least with processor 304, propulsion system 308, navigation system 312, sensor system 324, and power system 332 to allow vehicle 301 to operate autonomously. That is, autonomous vehicle 301 is able to operate autonomously through the use of an autonomy system that effectively includes, at least in part, functionality provided by propulsion system 308, navigation system 312, sensor system 324, power system 332, and control system 336. Components of propulsion system 308, navigation system 312, sensor system 324, power system 332, and control system 336 may effectively form a perception system that may create a model of the environment around autonomous vehicle 301 to facilitate autonomous or semi-autonomous driving.

As will be appreciated by those skilled in the art, when autonomous vehicle 301 operates autonomously, vehicle 301 may generally operate, e.g., drive, under the control of an autonomy system. That is, when autonomous vehicle 301 is in an autonomous mode, autonomous vehicle 301 is able to generally operate without a driver or a remote operator controlling autonomous vehicle. In one embodiment, autonomous vehicle 301 may operate in a semi-autonomous mode or a fully autonomous mode. When autonomous vehicle 301 operates in a semi-autonomous mode, autonomous vehicle 301 may operate autonomously at times and may operate under the control of a driver or a remote operator at other times. When autonomous vehicle 301 operates in a fully autonomous mode, autonomous vehicle 301 typically operates substantially only under the control of an autonomy system. The ability of an autonomous system to collect information and extract relevant knowledge from the environment provides autonomous vehicle 301 with perception capabilities. For example, data or information obtained from sensor system 324 may be processed such that the environment around autonomous vehicle 301 may effectively be perceived.

In one embodiment, a process of generating an inferred context map, as for example using machine learning or deep learning, onboard a vehicle includes incorporating prior data relating to context maps. The prior data may be used to effectively confirm that features included in the inferred context map are relatively accurately identified, and to effectively identify when discrepancies between features included in the inferred context map and features indicate by the prior data may substantially trigger a decision to be made as to whether the inferred context map meets a threshold level for use. The prior data may include, but is not limited to including, data associated with a previously inferred context maps and other maps used to facilitate the autonomous operation of vehicles, e.g., SD and HD maps. It should be appreciated that the prior data associated with previously inferred context maps is typically not manually labeled to identify features.

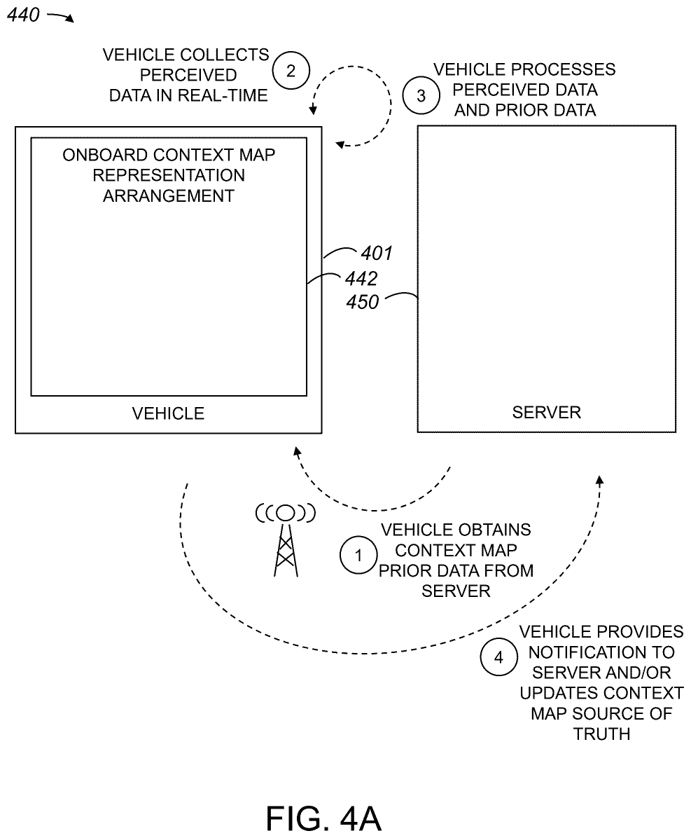

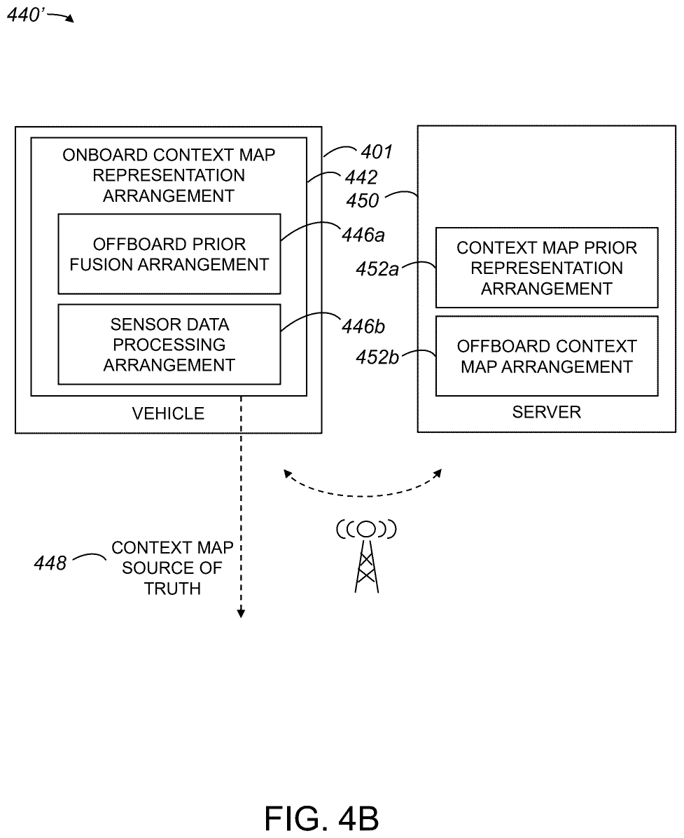

Referring next to FIG. 4A, a platform for providing machine learning-based context map inference that includes a vehicle and a server in accordance with an embodiment. A platform 440 or architecture includes a vehicle 401, which may include systems such as the systems included on vehicle 301 of FIG. 3, and a server 450. Vehicle 401 and server 450 may communicate over a network. Vehicle 401 has an onboard context map representation arrangement 442. Onboard context map representation arrangement 442 is configured to process data to create a context map that may be used by vehicle 401, e.g., a context map source of truth. Onboard context map representation arrangement 442 may include computer instructions or logic embodied on a computer readable medium that may be executed by a processing arrangement.

At a time t1, vehicle 401 obtains context map prior data from server 450, which is arranged to store and to substantially distribute context map prior data. At a time t2, vehicle 401 collects or otherwise obtains perceived data in real-time. In other words, vehicle 401 collects data using a sensor system on vehicle 401, e.g., sensor system 324 of FIG. 3. The data may effectively be collected as vehicle 401 operates.

At a time t3, vehicle 401 processes the perceived data and the prior data. Onboard context map representation arrangement 442 may process the perceived data and the prior data using one or more machine learning models to generate an inferred context map. In one embodiment, the perceived data is used to generate an inferred context map, and the prior data may be used to substantially validate features contained in the perceived data such that the features may be relatively safely incorporated into the inferred context map.

At a time t4, the vehicle 401 provides a notification to server 450 and/or updates a context map source of truth. The notification may enable server 450 to update prior data to include information relating to features associated with the perceived data. Updating the prior data may include updating a source of truth or ground truth associated with a context map stored on or otherwise maintained by server 450.

FIG. 4B is a diagrammatic representation of one embodiment of a platform for providing context map inference, e.g., platform 440 of FIG. 4A, in accordance with an embodiment. Platform 440′ includes vehicle 401, which includes onboard context map representation arrangement 442, and server 450.

Onboard context map representation arrangement 442 includes an offboard prior fusion arrangement 446a and a sensor data processing arrangement 446b. Offboard prior fusion arrangement 446a is configured to obtain map prior data from server 450, and sensor data processing arrangement 446b is configured to obtain data, e.g., perceived data, from sensor systems on vehicle 401. Offboard prior fusion arrangement 446a and sensor data processing arrangement 446b cooperate to identify features in perceived data, and to compare the features in perceived data to features in map prior data. Then, offboard context map representation arrangement 442 may generate or update a context map that is intended to be used by vehicle 401, and may be provided as a context map source of truth 448 to external systems, e.g., server 450.

Server 450 is generally arranged to store data and/or context maps. A context map prior representation arrangement 452a is configured to store data, e.g., prior data. An offboard context map arrangement 452b is used to generate context maps using data associated with context map prior representation arrangement 452a. In one embodiment, context map source of truth 448 may be provided to context map prior representation arrangement 452a and to offboard context map arrangement 452b.

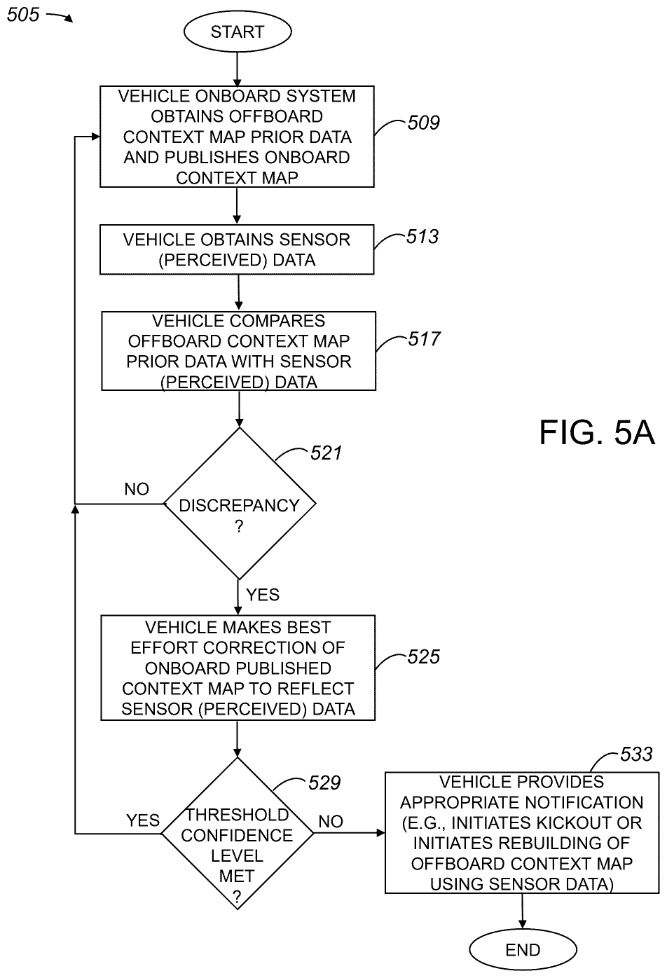

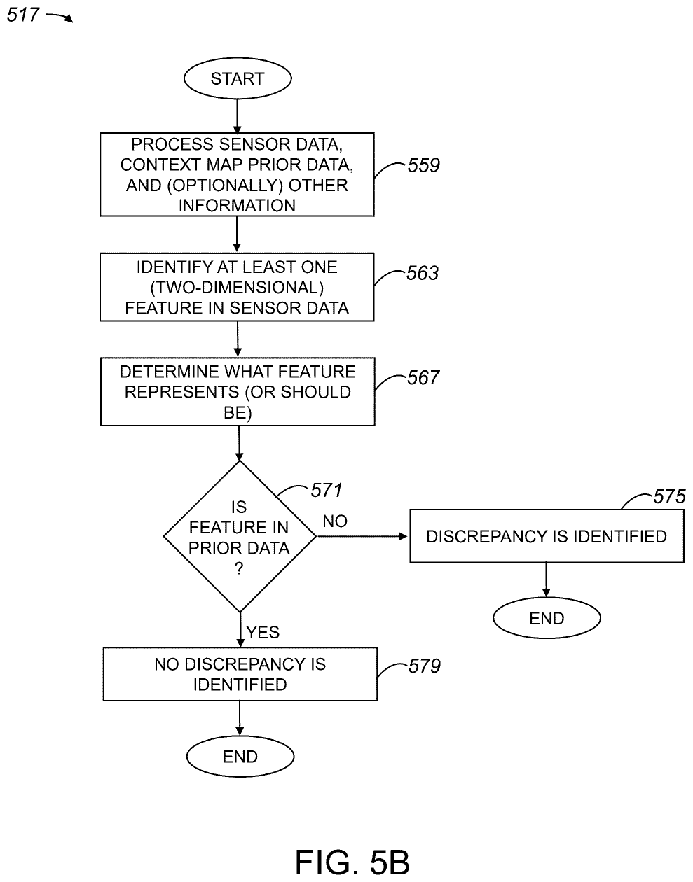

FIG. 5A is a process flow diagram which illustrates a general method of implementing context map inference on a vehicle in accordance with an embodiment. A method 505 of implementing context map inference begins at a step 509 in which a vehicle onboard system, as for example onboard context map representation arrangement of FIGS. 4A and 4B, obtains offboard context map prior data, and publishes and onboard context map that may be used by the vehicle for navigational purposes.

In a step 513, the vehicle obtains sensor data, e.g., data perceived by sensors on the vehicle. Once the vehicle obtains the sensor data, the vehicle compares the offboard context map prior data with the sensor data in a step 517. Comparing the data enables an assessment to be made as to whether features substantially identified in the sensor data have been accurately identified. In one embodiment, offboard context map prior data may be used to substantially validate the sensor data, and may effectively be considered to be a source or truth. One method of comparing offboard context map prior data with sensor data will be described below with respect to FIG. 5B.

A determination is made in a step 521 as to whether there is a discrepancy between the offroad context map prior data and the sensor data. The discrepancy may be, but is not limited to being, the indication of a feature in the sensor data that is not indicated in the offroad context map prior data and/or no indication of a feature in the sensor data that is indicated in the offroad context map prior data.

If it is determined in step 521 that there is no discrepancy, or that any discrepancy does not exceed a threshold amount, then process flow returns to step 509 in which the vehicle onboard system obtains offboard context map prior data. Alternatively, if it is determined in step 521 that there is a discrepancy, or if any discrepancy is greater than a threshold amount, the vehicle makes a best effort correction of an onboard published context map to reflect the sensor data in a step 525. Correcting the onboard published context map data may involve resolving a feature that is either perceived to be missing or extraneous with respect to the onboard published context map data. Upon resolving a feature, the onboard context map may be republished or otherwise updated to essentially reflect the sensor data.

Fron step 525, process flow proceeds to a step 529 in which it is determined whether a threshold confidence level is met. That is, a determination is made as to whether the discrepancy may present an issue that may have an effect on the ability of the vehicle to safely operate. If it is determined that a threshold confidence level is met, process flow returns to step 509 in which the vehicle onboard system continues to obtain offboard context map prior data and continues to publish an onboard context map.

Alternatively, if it is determined in step 529 that the threshold confidence level is not met, the implication may be that the discrepancy may have an effect on the ability of the vehicle to safely operate. As such, in a step 533, the vehicle provides an appropriate notification to other systems, e.g., a server on which the offboard context map prior data is stored. The appropriate notification may initiate a kickout from controlling the vehicle using autonomy to controlling the vehicle using a teleoperations system, and/or initiate a rebuilding an offboard context map based on the sensor data and the prior data. After the vehicle provides an appropriate notification, the method of implementing context map inference is completed.

FIG. 5B is a process flow diagram which illustrates a method of a vehicle comparing offboard context map prior data to sensor data, e.g., step 517 of FIG. 5A, in accordance with an embodiment. Method or step 517 of comparing offboard context map prior data to sensor data begins at a step 559 in which sensor data, context map prior data, and optionally other information are processed. The other information may include, but is not limited to including, historical information which may provide an indication of what the sensor data effectively shows. For example, the other information may facilitate an identification of a feature that is not included in context map prior data but is expected to be in the context map prior data.

In a step 563, at least one feature is identified in the sensor data. For example, at least one two-dimensional feature may be identified in the sensor data. Once at least one feature is identified in the sensor data, a determination is made in a step 567 as to what the feature represents, e.g., what the feature is expected to be or otherwise should be. By way of example, if the feature is located at an intersection, the feature may be expected to be a stop sign or a traffic signal.

A determination is made in a step 571 as to whether the feature identified in the sensor data is present in the context map prior data. If it is determined that the feature is not present in the context map prior data, a discrepancy is identified in a step 575, and the method of comparing offboard context map prior data to sensor data is completed.

Alternatively, if it is determined in step 571 that the feature identified in the sensor data is present in the context map prior data, the implication is that the context map is likely accurate. As such, no discrepancy is identified in a step 579, and the method of comparing offboard context map prior data to sensor data is completed.

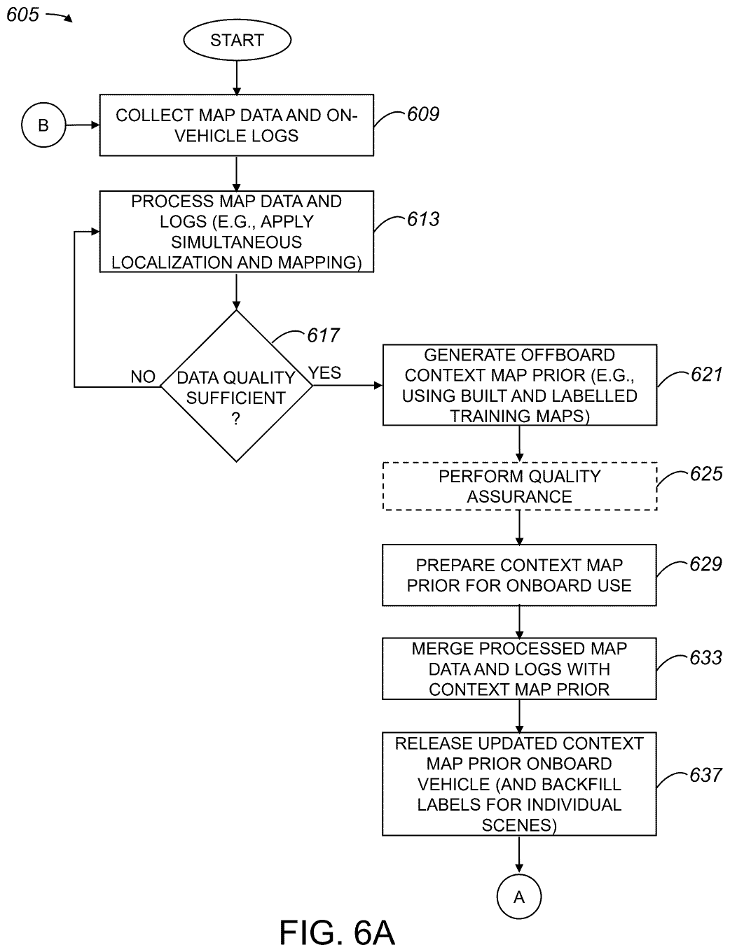

One specific method of implementing context map inference will be described with respect to FIGS. 6A and 6B in accordance with an embodiment. A method 605 of implementing context map inference begins at a step 609 in which map data and on-vehicle logs are collected while a vehicle is operating. The map data may generally include data collected from sensors onboard the vehicle.

The map data and logs are processed in a step 613. By way of example, substantially simultaneous localization and mapping may be applied to the map data and logs. Once the map data and logs are processed, a determination is made in a step 617 as to whether the data quality associated with the processed map data and processed logs is sufficient for use in generating a relatively accurate context map.

If it is determined in step 617 that the data quality is not sufficient, then process flow returns to step 613 in which the map data and the logs are once again processed. On the other hand, if the determination is that the data quality is sufficient or otherwise adequate, an offboard context map prior is generated in a step 621. The offboard context map prior may be generated on a server or other system that is remote from, but in communication with, the vehicle. The offboard context map prior may be generated using, but is not limited to being generated using, built and labelled training maps. From step 621, process flow proceeds to an optional step 625 in which quality assurance is performed with respect to the generated offboard context map prior. When quality assurance is performed, a determination is effectively made regarding the accuracy of an offboard context map prior, e.g., a third-party map.

In a step 629, the context map prior may be prepared for onboard use on the vehicle. Preparing the context map prior may generally include providing the context map prior to the vehicle. Processed map data and logs are merged with the context map prior in a step 633. In one embodiment, the merging occurs onboard the vehicle.

After the processed map data and logs are merged with the context map prior, the updated context map prior is released onboard the vehicle in a step 637. Such a release may include backfilled labels for individual scenes.

In a step 641, an onboard model, e.g., an onboard machine learning model, predicts map and map change classifications for the updated context map prior or prior map. The predictions may utilize an online bird's-eye-view (BEV) backbone. As will be discussed below, a BEV backbone facilitates generating a two-dimensional plane or view of a space around a vehicle, as for example a two-dimensional embedding, by effectively fusing inputs from multiple sensors.

A determination is made in a step 645 as to whether a change in a prior map is observed. If it is determined that no change on the prior map is observed, process flow proceeds to a step 649 in which updated on-vehicle logs are generated. Once the updated on-vehicle logs are generated, process flow returns to step 609 in which map data and on-vehicle logs are collected.

Returning to step 645, if a change in the prior map is observed, then in a step 653, it is determined whether the change indicates a predicted loss and, hence, whether the predicted loss exceeds a threshold. That is, it is determined whether a discrepancy in the prior map falls below a threshold value or amount which may identify the discrepancy as being relatively significant.

If it is determined that the predicted loss exceeds a threshold, the log is identified as difficult in a step 661, and measures of uncertainty are published onboard. Once the measures of uncertainty are published, the on-vehicle logs are generated in step 649.

Alternatively, if it is determined in step 653 that the predicted loss does not exceed the threshold, the vehicle is allowed to operate. That is, the vehicle is allowed to operate through a scene change associated with the change in the prior map. From step 657, process flow returns to step 641 in which the onboard model predicts the map and map change classifications.

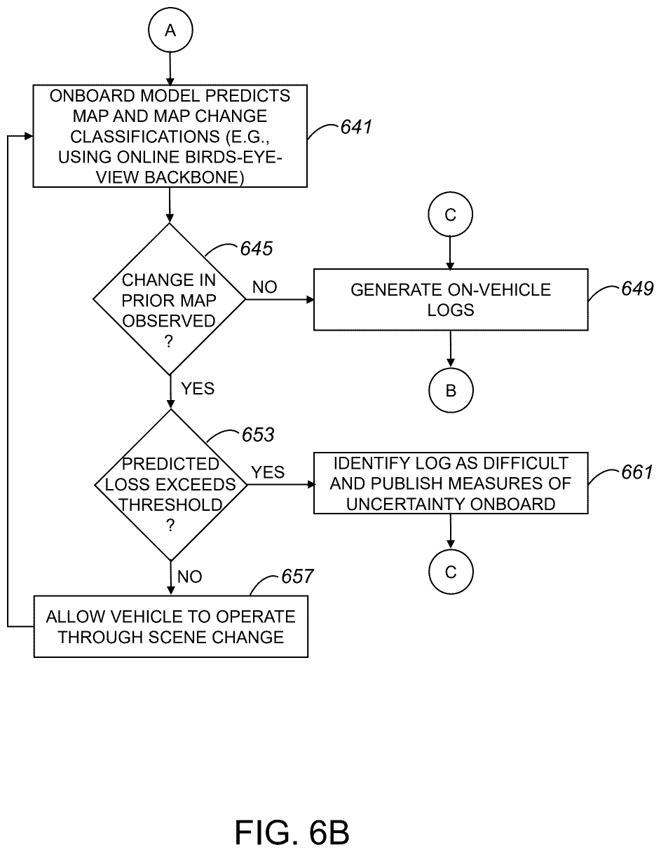

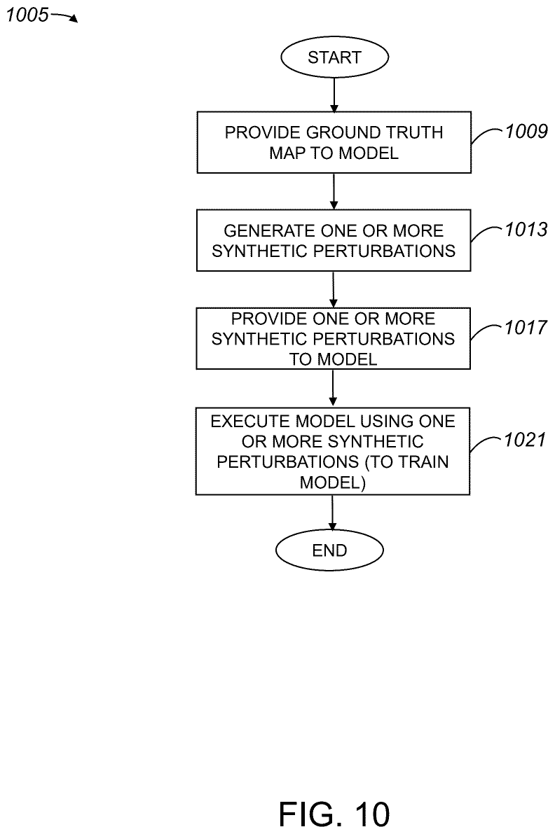

FIG. 7 is a diagrammatic representation of a vehicle architecture which produces an inferred context map for use by an autonomy system in accordance with an embodiment. An onboard context map generation arrangement 742 that is onboard a vehicle includes at least one machine learning model 756. Machine learning model 756 may generally be any suitable machine learning model, and may be embodied as logic and/or executable code devices on a computer-readable medium that may be executed by a processing arrangement on the vehicle. For example, machine learning model 756 may include a deep neural network model or a deep learning model. In general, machine learning model 756 may effectively understand and address occlusions, changes in maps, construction zones, and/or implicit map features. It should be appreciated that machine learning model 756 may generally be trained using inputs, e.g., a training set, to enable machine learning model 756 to identify patterns and/or to generate predictions with respect to a context map. The accuracy of machine learning model 756 may be determined using a testing set of data after machine learning model 756 is trained using a training set of data. One method of training a machine learning model such as machine learning model 756 will be discussed below with respect to FIG. 10.

Onboard context map generation arrangement 742 is arranged to obtain onboard sensor data 758 and offboard prior context data 762. In one embodiment, offboard prior context data 762 may be used by onboard context map representation arrangement 742 as a prediction, or a prediction for what an onboard context map is expected to include. Machine learning model 756 processes onboard sensor data 758 and offboard prior context data 762 to generate an inferred context map 768. Inferred context map 768 may be provided to an autonomy system 764 of the vehicle, and autonomy system 764 may use inferred context map 768 to generate one or more vehicle commands 766. The one or more vehicle commands 766 may be provided to various systems of the vehicle to enable the vehicle to drive in an autonomous manner. For example, inferred context map 768 may be used by autonomy system 764 to issue one or more vehicle commands 766 to cause a vehicle to drive autonomously to a desired or target destination.

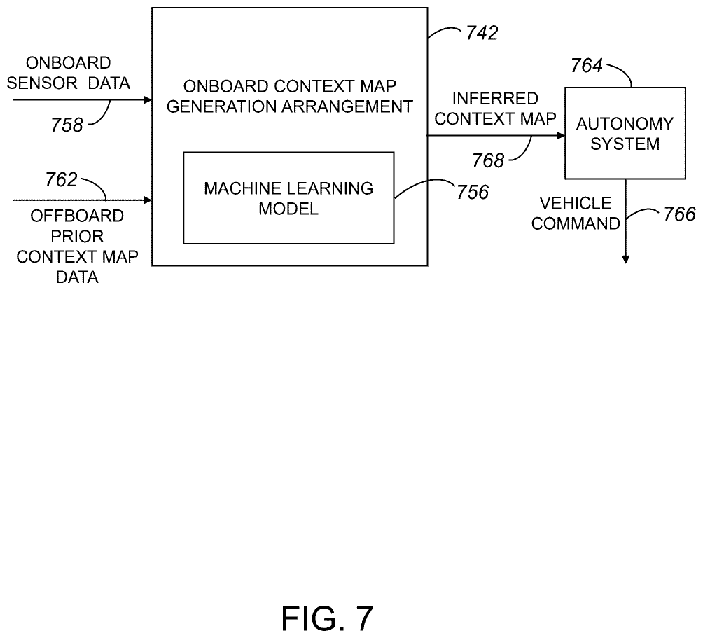

In one embodiment, onboard sensor data 758 may be processed before being provided to onboard context map generation arrangement 742. FIG. 8 is a diagrammatic representation of a vehicle architecture which is arranged to process onboard sensor data 758 before providing onboard sensor data 758 to machine learning model 756 in accordance with an embodiment. Onboard sensor data 758 includes, but is not limited to including, camera data 758a and lidar data 758b. Camera data 758a may be obtained from one or more cameras onboard a vehicle, and lidar data 758b may be obtained from one or more lidar systems on the vehicle.

Camera data 758b and lidar data 758b are provided to a concatenation arrangement 870 which processes camera data 758b and lidar data 758b to generate concatenated data 872. Concatenated data 872, or fused camera data 758a and lidar data 758b, is then provided to a BEV backbone arrangement 874. BEV backbone arrangement 874 generated processed onboard sensor data 858. In one embodiment, processed onboard sensor data 858 includes a two-dimensional embedding of camera data 758a and lidar data 758b. Processed onboard sensor data 858 may be a BEV of a two-dimensional space around a vehicle.

Processed onboard sensor data 858 and offboard prior context map data 762 may be provided as input to onboard context map generation arrangement 742. Machine learning model 756, or a map prediction model. uses processed onboard sensor data 858 and offboard prior context map data 762 to generate inferred context map 768.

While the generation of an inferred context map or onboard context map has generally been described as including identifying discrepancies between an offboard context prior data and sensor data obtained by an autonomous vehicle, it should be appreciated that in some situations, an inferred context map that is generated by a map generation arrangement such as map generation arrangement 742 of FIGS. 7 and 8 does not necessarily involve identifying discrepancies. For example, a map generation arrangement may be trained to process sensor data and incorporate features from the sensor data in an inferred context map.

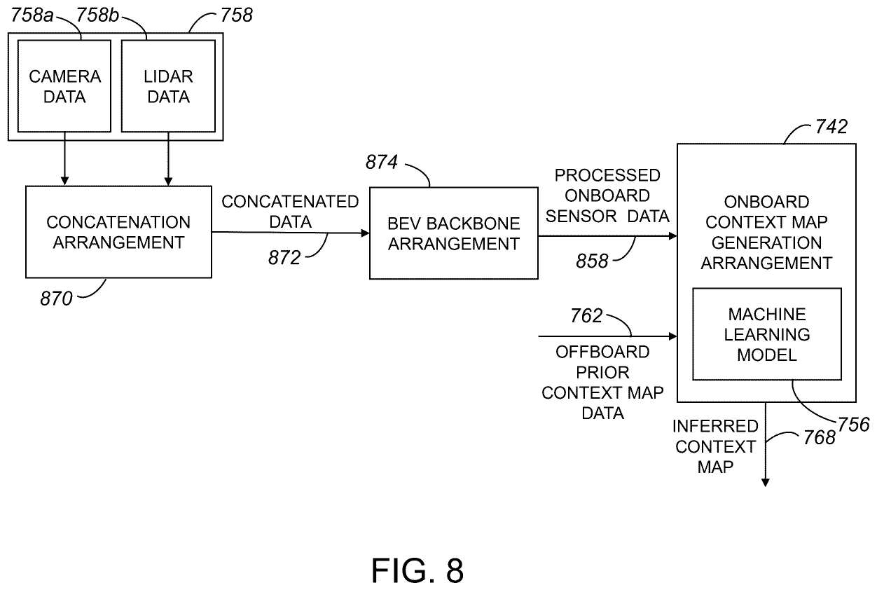

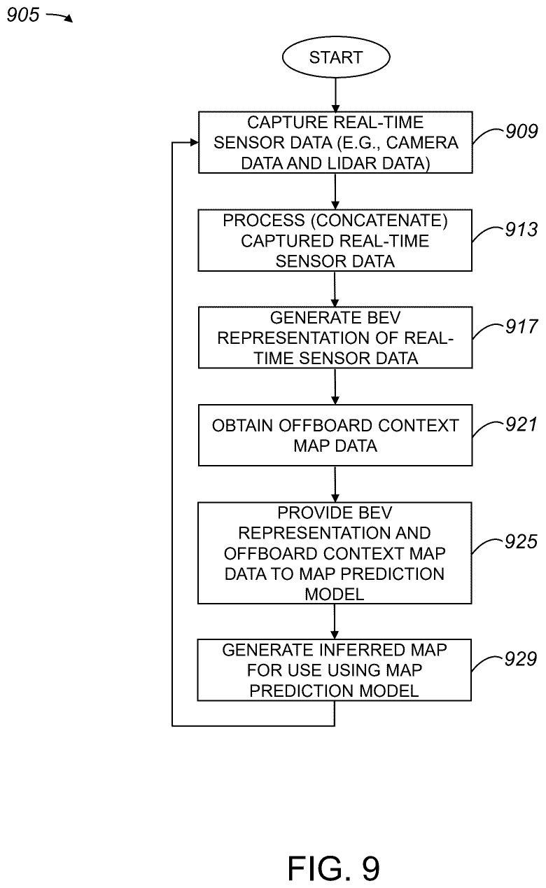

With reference to FIG. 9, a method of generating an inferred context map that does not involve processing discrepancies will be described in accordance with an embodiment. A method 905 of generating an inferred context map begins at a step 909 in which real-time sensor data, e.g., camera data and lidar data, is captured or otherwise obtained from sensors on a vehicle. The captured real-time sensor data is processed in a step 913. For example, camera data and lidar data is effectively ingested by a concatenation arrangement such as concatenation arrangement 870 of FIG. 8, and concatenated data or a two-dimensional representation of the camera data and lidar data is created.

Using the processed real-time sensor data, a BEV representation is generated in a step 917. The BEV representation may be generated, as for example by a BEV backbone such as BEV backbone arrangement 874 of FIG. 8, by extracting features such as two-dimensional features from the processed real-time sensor data, and effectively embedding the two-dimensional features in two-dimensional space substantially around the vehicle.

In a step 921, offboard context map data is obtained. It should be appreciated that the offboard context map data may be obtained at substantially any time. The offboard context map data, or prior map data, and the BEV representation are provided to a map prediction or machine learning model in a step 925.

Once the map prediction or machine learning model obtains the offboard context map data and the BEV representation, process flow proceeds to a step 929 in which the map prediction or machine learning model generates an inferred map. In one embodiment, the BEV representation may include a two-dimensional embedding, and generating the inferred map may include geospatially aligning the offboard context map data, or the offboard map prior data, such that the offboard context map data may be aligned with the BEV representation. From step 929, process flow returns to step 909 in which real-time sensor data is captured.

As previously mentioned, training or teaching a machine learning model such as machine learning model 756 of FIG. 7 facilitates the ability of a machine learning model to make accurate predictions and/or decisions. FIG. 10 is a process flow diagram which illustrates a method of training a map prediction or machine learning model in accordance with an embodiment. A method 1005 of training a map prediction or machine learning model begins at a step 1009 in which a ground truth map is provided to the map prediction or machine learning model. A ground truth map may effectively be prior map data that is known to be accurate.

In a step 1013, one or more synthetic perturbations is generated. The synthetic perturbations are generated to effectively introduce artificial degradations that enable the map prediction or machine learning model to learn how to process degradations that may be sensed by sensors of an autonomous vehicle which subsequently runs the map prediction or machine learning model. The synthetic perturbations may effectively simulate real world changes, e.g., degradations, and may be arranged to enable the map prediction or machine learning model to effectively learn how to process the real world changes.

Once the one or more synthetic perturbations are generated, the one or more synthetic perturbations are provided to the map prediction or machine learning model in a step 1017. The map prediction or machine learning model then executes the map prediction or machine learning model in a step 1021 using the one or more synthetic perturbations. After the map prediction or machine learning model executes using the one or more perturbations, the method of training a map prediction or machine learning model is completed

Although only a few embodiments have been described in this disclosure, it should be understood that the disclosure may be embodied in many other specific forms without departing from the spirit or the scope of the present disclosure. By way of example, in addition to using offboard prior context data to effectively supplement onboard sensor data when an inferred context map is being generated, additional map data such as data associated with third party and/or commercial maps may be used.

In one embodiment, semantic map attributes and associations may be substantially focused on lane topology predictions. A Graph Neural Network (GNN) edge classification approach in addition to point/polyline/polygon detection may facilitate the generation of semantic map attributes and associations. A heuristic solution may use previously labeled topology for roads with relatively major changes, although it should be understood that a map prediction or machine learning model may be such that heuristics are not involved. Semantic map attributes and associations may include, but are not limited to including, lane relations with respect to exiting one lane and entering another lane, sign-lane associations, traffic signal bulb types and rights of way, stop sign attributes, and/or implicit pedestrian paths,

An offboard model may construct a vectorized context map. The output of the offboard model may be used for supervision during training, and may be used as a direct or intermediate format for data that is provided to and onboard model, and/or data that is consumed offboard by downstream users.

In one embodiment, a machine learning model that includes a deep neural network model may use heuristics and/or a learned algorithm to substantially ensure quality and stability of context map feature inference. In another embodiment, a machine learning model may provide information downstream relating to localization, prior map noise, and sensor noise.

An autonomous vehicle has generally been described as a land vehicle, or a vehicle that is arranged to be propelled or conveyed on land. It should be appreciated that in some embodiments, an autonomous vehicle may be configured for water travel, hover travel, and or/air travel without departing from the spirit or the scope of the present disclosure. In general, an autonomous vehicle may be any suitable transport apparatus that may operate in an unmanned, driverless, self-driving, self-directed, and/or computer-controlled manner.

In general, while an autonomous vehicle has been described as being arranged to transport goods, it should be appreciated that an autonomous vehicle may additionally, or alternatively, be configured to transport passengers. That is, an autonomous vehicle is not limited to transporting goods.

The embodiments may be implemented as hardware, firmware, and/or software logic embodied in a tangible, i.e., non-transitory, medium that, when executed, is operable to perform the various methods and processes described above. That is, the logic may be embodied as physical arrangements, modules, or components. For example, the systems of an autonomous vehicle, as described above with respect to FIG. 3, may include hardware, firmware, and/or software embodied on a tangible medium and carried on a chassis or body of the vehicle. A tangible medium may be substantially any computer-readable medium that is capable of storing logic or computer program code which may be executed, e.g., by a processor or an overall computing system, to perform methods and functions associated with the embodiments. Such computer-readable mediums may include, but are not limited to including, physical storage and/or memory devices. Executable logic may include, but is not limited to including, code devices, computer program code, and/or executable computer commands or instructions. It should be appreciated that a vehicle on which a map prediction arrangement is onboard the vehicle may include computing systems, as for example computer-readable storage mediums on which logic or code devices may be stored, carried on the vehicle chassis.

It should be appreciated that a computer-readable medium, or a machine-readable medium, may include transitory embodiments and/or non-transitory embodiments, e.g., signals or signals embodied in carrier waves. That is, a computer-readable medium may be associated with non-transitory tangible media and transitory propagating signals.

The steps associated with the methods of the present disclosure may vary widely. Steps may be added, removed, altered, combined, and reordered without departing from the spirit of the scope of the present disclosure. Therefore, the present examples are to be considered as illustrative and not restrictive, and the examples are not to be limited to the details given herein, but may be modified within the scope of the appended claims.

What is claimed is:

1. A method comprising:
obtaining sensor data from a plurality of sensors, the plurality of sensors being onboard a vehicle;
obtaining prior map data from a server, the server being offboard with respect to the vehicle;
processing the sensor data using a first arrangement to generate processed sensor data, the first arrangement being located onboard the vehicle; and
generating an inferred context map using a map prediction arrangement located onboard the vehicle, wherein generating the inferred context map includes processing the processed sensor data and the prior map data using the map prediction arrangement.

2. The method of claim 1 wherein processing the sensor data using the first arrangement to generate the processed sensor data includes:
generating a bird's-eye-view (BEV) representation of the sensor data using the first arrangement, wherein the processed sensor data includes the BEV representation.

3. The method of claim 2 wherein the plurality of sensors includes at least one camera and at least one lidar, the sensor data including camera data obtained from the at least one camera and lidar data obtained from the at least one lidar, and wherein processing the sensor data using the first arrangement to generate the processed sensor data further includes:
concatenating the camera data and the lidar data to generate concatenated sensor data using the first arrangement, wherein generating the BEV representation of the sensor data includes processing the concatenated sensor data.

4. The method of claim 3 further including:
providing the inferred context map to an autonomy system onboard the vehicle, wherein the autonomy system is arranged to generate at least one vehicle command to control the vehicle.

5. The method of claim 3 further including:
identifying at least one feature in the processed sensor data;
determining whether the at least one feature is included in the prior map data;
identifying a discrepancy when it is determined that the at least one feature is not included in the prior map data, wherein generating the inferred context map using the map prediction arrangement includes adding the at least one feature to the inferred map when the discrepancy is identified.

6. The method of claim 1 wherein the map prediction arrangement includes a machine learning model.

7. The method of claim 1 wherein obtaining the sensor data includes obtaining the sensor data in real-time as the vehicle operates.

8. Logic encoded in one or more tangible non-transitory, computer-readable media for execution and when executed operable to:
obtain sensor data from a plurality of sensors onboard a vehicle;
obtain prior map data from a server, the server being offboard with respect to the vehicle;
process the sensor data to generate processed sensor data onboard the vehicle; and
generate an inferred context map onboard the vehicle, wherein the logic operable to generate the inferred context map includes logic operable to process the processed sensor data and the prior map data.

9. The logic of claim 8 wherein the logic operable to process the sensor data to generate the processed sensor data is further operable to generate a bird's-eye-view (BEV) representation of the sensor data, wherein the processed sensor data includes the BEV representation.

10. The logic of claim 9 wherein the plurality of sensors includes at least one camera and at least one lidar, the sensor data including camera data obtained from the at least one camera and lidar data obtained from the at least one lidar, and wherein the logic operable to process the sensor data to generate the processed sensor data is further arranged to concatenate the camera data and the lidar data to generate concatenated sensor data, wherein the logic operable to generate the BEV representation of the sensor data is further operable to process the concatenated sensor data.

11. The logic of claim 10 wherein the logic is further operable to provide the inferred context map to an autonomy system onboard the vehicle, wherein the autonomy system is arranged to generate at least one vehicle command to control the vehicle.

12. The logic of claim 10 wherein the logic is further operable to:
identify at least one feature in the processed sensor data;
determine whether the at least one feature is included in the prior map data;
identify a discrepancy when it is determined that the at least one feature is not included in the prior map data, wherein the logic operable to generate the inferred context map is further operable to add the at least one feature to the inferred map when the discrepancy is identified.

13. The logic of claim 8 wherein the logic operable to generate the inferred context map includes a machine learning model.

14. A vehicle comprising:
a chassis;
a sensor system carried on the chassis;
a communications system carried on the chassis;
one or more tangible non-transitory, computer-readable media carried on the chassis; and
logic encoded in the one or more tangible non-transitory, computer-readable media for execution and when executed operable to:
obtain sensor data from the sensor system,
obtain prior map data from a server using the communications system, the server being offboard with respect to the vehicle,
process the sensor data to generate processed sensor data, and
generate an inferred context map, wherein the logic operable to generate the inferred context map includes logic operable to process the processed sensor data and the prior map data.

15. The vehicle of claim 14 wherein the logic operable to process the sensor data to generate the processed sensor data is further operable to generate a bird's-eye-view (BEV) representation of the sensor data, wherein the processed sensor data includes the BEV representation.

16. The vehicle of claim 15 wherein the sensor system includes at least one camera and at least one lidar, the sensor data including camera data obtained from the at least one camera and lidar data obtained from the at least one lidar, and wherein the logic operable to process the sensor data to generate the processed sensor data is further operable to concatenat3 the camera data and the lidar data to generate concatenated sensor data, wherein the logic operable to generate the BEV representation of the sensor data is further operable to process the concatenated sensor data.

17. The vehicle of claim 16 further including:
an autonomy system carried on the chassis, the autonomy system being configured to enable the vehicle to drive autonomously, wherein the logic is further operable to provide the inferred context map to the autonomy system, wherein the autonomy system is arranged to generate at least one vehicle command to control the vehicle.

18. The vehicle of claim 16 wherein the logic is further operable to:
identify at least one feature in the processed sensor data;
determine whether the at least one feature is included in the prior map data;
identify a discrepancy when it is determined that the at least one feature is not included in the prior map data, wherein the logic operable to generate the inferred context map is operable to add the at least one feature to the inferred map when the discrepancy is identified.

19. The vehicle of claim 14 wherein the logic operable to generate the inferred map includes a machine learning model.

20. The vehicle of claim 14 wherein the logic operable to obtain the sensor data is operable to obtain the sensor data in real-time as the vehicle operates.
